(19) United States
(12) Patent Application Publication
(10) Pub. No.: US 2011/0240802 A1
(43) Pub. Date: Oct. 6, 2011

(54) DEVICE FOR TRANSPORTING AND EJECTING SMALL SPACE PAYLOADS

(76) Inventor: Spas Balinov, Villeurbanne (FR)

(21) Appl. No.: 13/129,630

(22) PCT Filed: Nov. 26, 2009
(86) PCT No.: PCT/FR2009/001345

§ 371 Date: Jun. 9, 2011

(30) Foreign Application Priority Data
Nov. 26, 2008 (FR) 0806637

(51) Int. Cl. B64G 1/64

(52) U.S. Cl. 244/173.3

(57) ABSTRACT

A device for transporting and ejecting small space payloads, in particular picosatellites, including a tubular body provided with a device for attachment onto a launch vehicle, the body including at least two longitudinal guide rails which can receive a satellite fixedly arranged inside the body in a storage position during transport and which can be moved along the guide rails towards a front end of the body during ejection, an ejection mechanism including a device for translatably moving a satellite in a longitudinal fashion, a drive device connected to the movement device and suitable for engaging with a satellite, and a device for controlling the ejection mechanism. According to the invention, the movement device includes a transport device including at least one cable extending in a closed loop inside the body, the closed loop passing around said guide rails and including passage areas extending in parallel on either side of the guide rails so that when the cable is moved by the control unit, the drive device can move a satellite on the rails towards the front end of the body.

### FIELD OF THE INVENTION

This invention relates to the field of systems for launching small space payloads from a space launching vehicle, and more specifically small satellites, such as picosatellites.

### PRIOR ART

Launching vehicles are designed to transport and eject large payloads, which are generally heavy and expensive. These vehicles can also release small payloads, such as small satellites released from the space shuttle loading holds. The systems for deploying these payloads generally comprise pyrotechnic devices or devices with a spring loaded actuator.

Document U.S. Pat. No. 5,253,827 describes a system for deploying a small satellite comprising, inside a vehicle deployment chamber, guide rails on which synchronized power-operated chains travel and cooperating with attachment elements secured to the satellite to be launched. The power-operated chains make it possible to drive the attachment elements and therefore to accelerate the satellite along the rails, leaving them at their upper end, causing the satellite to be released. While ensuring safer operation than pyrotechnic devices, this device has the disadvantages of being intended to launch a single satellite, of therefore requiring significant launching costs and of using a chain that may be subject to seizures, in particular when the working conditions with significant temperature variations present chain lubrication problems. Moreover, due to the fact that each guide rail has its own power-operated chain, the device must use mechanisms for synchronizing the different chains with one another, which must be adjusted very precisely in order to be capable of properly driving the satellite in translation along the guide rails. This makes the construction of the device complex, expensive and unreliable to operate. Thus, when one of the chains does not operate properly, or in the event of an imperfect synchronization of the chains with one another, and in particular when the weight of the satellite is high, lateral load tipping moments of the satellite may occur as it is launched with significant consequences on its launching trajectory.

A solution has been provided by scientific organizations and universities, which have developed small satellites, in particular picosatellites, and the associated launchers thereof make it possible, by simplifying them and reducing their size, to reduce the cost and time necessary for their development. Picosatellites have a wide range of applications, generally scientific, for communication or observation, and the deployment device is attached as a secondary payload for commercial satellite launching. Picosatellites are space payloads having a mass of several hundred grams. Researchers at the California Polytechnic State University, San Luis Obispo and the Space System Development Laboratory of Stanford University introduced a standard for the design of small satellites, called CubeSat. The CubeSat standard, known to a person skilled in the art, defines each satellite as being a cube with 10-cm sides and a weight of up to 1 kg. The satellites produced according to this standard can be launched at a lower cost by using launchers outside the launching vehicle. Such a launcher is a tube with a square cross-section containing three secured satellites and capable of moving inside the tube, on slide rails, by being pushed by a spring-loaded mechanism. The tube is closed by a locked pivoting door, and the ejection mechanism is located opposite the door. In operation, when the vehicle reaches the launching altitude, a command is sent to the satellite ejection mechanism, which actuates the mechanism to open the door, and the mechanism to release the spring. While allowing for more economical launching of satellites, this solution has the disadvantage of difficulty controlling the altitude and orbital position of each satellite, and of causing communication interference, as the three satellites remain joined together, from the time of launching, for a period of several weeks. In addition, the shape and structure of a satellite is limited to that of cube and three cubes are joined, by being arranged one against the other inside the device, without the possibility of adding auxiliary devices to the structure of each, such as solar panels. Moreover, their ejection speed is dependent on the technical features of the spring and the tensioning thereof, as established when the satellites are mounted in the launcher.

A solution has been provided in the article “FlyMate: The Lyon Femto Orbital Deployer for Future Distributed Space Mission” presented by the applicant at the 59th International Astronautics Conference, in which the launching device includes a tube with a square cross-section inside of which a plurality of satellites produced according to the CubeSat standard are inserted, but in which the deployment mechanism is a power-operated chain mechanism. While making it possible to better choose the time and speed of deployment of a plurality of satellites, in particular according to the intended mission, with the same device, by controlling the operation of the electric drive motor, this device nevertheless has the disadvantage of using grouped satellites, in which each satellite has the shape of a cube, and a plurality of satellites are arranged one against another. Owing to their very close arrangement in the common structure, these satellites are difficult to control after being launched. Moreover, the power-operated chain drive mechanism presents problems of reliability, in particular due to a possible seizure of the chain, lubrication problems, and so on.

Solutions to these disadvantages are known from document FR 2 859 456, which uses a power-operated release mechanism, or document WO 2008/034550 which uses a spring loaded ejection mechanism combined with an improved door locking mechanism, and in which the device is intended to eject a single picosatellite. However, the advantage conferred by the use of a simplified satellite is cancelled out by the use of a dedicated launching device. Consequently, the launching of a plurality of satellites requires the use of a plurality of launching devices outside the space shuttle, which increases the bulk thereof and significantly increases the launching costs.

### OBJECTIVE OF THE INVENTION

The objective of the invention is to overcome the aforementioned disadvantages and to provide a device for transporting and ejecting small space payloads, in particular picosatellites, with a simplified construction and reliable operation while enabling satellite launching according to pre-established launching parameters, specific to the satellite to be launched.

Another objective of the invention is to provide a device for transporting and ejecting picosatellites offering good stability for the satellite as it is moved and launched, while being capable of being obtained with low costs of production and integration in the launching vehicle.

Another objective of the invention is to provide a device for transporting and ejecting picosatellites capable simultaneously of containing, protecting, during flight, and launching a plurality of satellites, while being capable of adapting the launching parameters of each satellite to the mission intended for same.

Another objective of the invention is to provide a self-operating device for transporting and ejecting picosatellites, making it possible to place a plurality of satellites in orbit, while being capable of attaching them to the additional devices in order to be capable of increasing the lifetime of each satellite.

These objectives are achieved with a device for transporting and ejecting small space payloads, in particular picosatellites, including:
a body with a tubular shape equipped with means for attachment to a launching vehicle; said body comprises at least two longitudinal guide rails capable of receiving a satellite arranged stationarily inside said body in a storage position during transport and capable of being caused to move along said guide rails in the direction of a front end of said body during ejection;
an ejection mechanism comprising means for moving a satellite in a longitudinal translation movement;
drive means connected to said moving means, capable of cooperating with a satellite; and
means for controlling the ejection mechanism,

in which said moving means include a transport installation comprising at least one cable extending in a closed loop inside the body, said closed loop passes around said guide rails and comprises passage areas extending parallel on each side of the guide rails so that, when said cable is moved by said control unit, it actuates said drive means so as to move the satellite on said rails in the direction of the front end of said body.

Thus, the device of the invention enables the transport and ejection of small space payloads or picosatellites (which will be called satellites below), more specifically because said moving means comprise a cable extending in a closed loop inside the body of the device, around but beyond the guide rails so that all of the drive means acting on the satellite are activated when the cable is caused to move. A movement of the satellite on two parallel rails is thus obtained by using a single cable, which makes it possible to do without any synchronization device or mechanism and to obtain a simplified construction of the device, which is thus more reliable to operate. The movement of the cable is controlled by the control unit, which makes it possible to adapt the movement of the cable (the time at which it is started, the speed of movement thereof), and therefore the means for driving the satellite, to the mission of the satellite to be launched.

To produce a closed loop circuit, the cable is caused to move by a driving pulley, or by a drum receiving the rotation movement of an electric motor, and passes through a plurality of intermediate or transfer pulleys before being wound on the driving pulley or the drum.

The drive means can be borne by the cable or the satellite and make it possible to transfer movement between the cable and the satellite. Thus, the movement of a satellite is produced when the cable causes the drive means to move, and all of the means for driving a satellite can advantageously, according to the invention, be caused to move by the same cable. This presents the advantage of obtaining a synchronized and simultaneous movement of all of the drive means, without the use of mechanisms for synchronizing the different drive means, for example as described in document U.S. Pat. No. 5,253,827, which are complex and require very precise development in order to ensure the proper operation of the device.

Moreover, unlike driving with a power-operated chain, a cable transport installation successfully resists significant variations in temperature (on the order of −60° C. to 100° C.), it does not require lubrication, and it is not subject to seizures, making it a reliable moving device for launching small space payloads. Thus, a smooth, uniform movement of the satellites on the rails is obtained, while using a device that is reliable to operate and capable of being produced inexpensively.

According to an advantageous feature of the invention, the drive means are intended to drive each satellite individually and are independent on the satellite guide means. Thus, the function of the guide means is separate from the satellite driving function for the ejection of said satellite. The guiding is achieved by using guide rails belonging to the rigid body of the device, which confers good stability on the system during the movement of the satellites on the rails. In addition, due to the use of guide means that are independent of the satellite drive means, the structure of the device is simplified, while being very reliable to operate. Thus, these drive means can, for example, be simple push members in contact with each satellite, which are arranged outside of the guide rails of the satellite. This mechanical construction of the device ensures very good guiding during the translation movement of each satellite, while being stronger and more reliable to operate.

In a preferred embodiment of the invention, said cable extends in a closed loop from a driving pulley that is located at the rear end of said body, the cable leaving the driving pulley passes through an angle deflection pulley, then through a lower front pulley causing it to make a half-turn toward the lower rear pulley, from which it is sent to an upper rear pulley, then to an upper front pulley, causing it to make a half-turn toward the driving pulley.

Advantageously, said transport installation includes two parallel cables following the same closed loop path from the same driving pulley.

It could of course have been possible to use a single transport cable supporting the drive elements engaging with each satellite at the center of each face of same. It is preferable, however, to arrange the drive elements at each end of the upper face and the lower face thereof, so as to ensure a uniform movement with the least effort for each drive element of each satellite.

Preferably, said driving pulley contains an electric motor of which the current power supply is controlled by said control means.

Thus, a driving pulley with a compact design and a transport installation with reduced bulk is obtained.

In a preferred embodiment of the invention, said drive means are intended to be capable of cooperating with at least two satellites arranged one behind the other, inside said body, in which the drive means are intended to drive each satellite individually. This makes it possible to launch each satellite with launching parameters that are specific to the satellite and that are different from those of the other satellites, while maximizing the efficiency of the device of the invention.

Thus, the device of the invention is capable of receiving, then simultaneously moving inside the body of the device, at least two satellites, preferably three satellites, while making it possible to launch each satellite individually. In other words, this device is capable of storing at least two satellites together for transport until they are launched into orbit, while being capable of ejecting each satellite individually, in which the ejection parameters of the satellite to be launched (in particular the time of the launching and the driving speed) are received by the moving means in the form of signals coming from the control unit.

According to an advantageous aspect of the invention, drive means cooperate with each satellite individually, and said drive means are capable of causing at least two satellites to move, which satellites can be arranged one behind the other, inside said body, and of ejecting one satellite at a time, according to signals received from said control means. Thus, when it is controlled by the control means, said drive means make it possible to drive all of the satellites together, and eject a single satellite at a time. The ejection of a satellite is therefore performed independently of that of the other satellites.

Thus, when the drive means receive signals coming from said control means, they cause all of the satellites to move, at the speed required for launching the satellite located closest to the ejection outlet of the device. The means for driving each satellite are produced so as to be capable of disengaging from the satellite or the moving means upon reaching an open end or an end for ejection of said body. By continuous movement device, we mean a mechanism capable of operating continuously and smoothly, between the time at which a start signal is received and the time at which a stop signal is received. The continuous movement mechanism for at least two satellites thus makes it possible to eject one satellite at a time, when the latter has reached the ejection end of the body of the device. The continuous movement mechanism can continue its longitudinal translation movement in order to eject a second satellite, at the same speed or at a different speed from the drive speed of the previous satellite, or it can be stopped by the control means. The movement of the continuous movement mechanism begins again when it receives a new signal coming from the control means to eject another satellite.

Thus, each satellite is launched into orbit individually, with launching parameters specific to the satellite (altitude, orbital position, launching speed), while being capable of transporting a plurality of satellites in the same device. In addition, by using a continuous movement mechanism comprising means for driving each satellite, all of the satellites are caused to move simultaneously inside the device, which means that, after the satellite closest to the outlet of the device has been ejected, the remaining satellites are already closer to the ejection outlet of the device, simplifying and speeding up the next launching.

Advantageously, two adjacent satellites are arranged at a predetermined distance from one another inside said body.

This makes it possible to use satellites having auxiliary devices, axially exceeding the space provided for them, such as solar panels, antennas, and so on.

Preferably, said control means include a microprocessor/microcontroller and said distance is introduced into the memory of the microprocessor/microcontroller.

This makes it possible to know the exact position of each satellite and to reliably control the time of launching thereof.

Advantageously, said drive means are mounted stationarily on said cable and are capable of becoming disengaged from the satellite at the time of ejection of the latter.

In an alternative, it could be possible to have drive means mounted stationarily on the satellite, and mounted removably on the cable, so that they can be disengaged from the cable at the time of ejection of the satellite. However, it is preferable to mount them stationarily on the cable so that they become disengaged from the satellite at the time of launching so as not to encumber the satellite with devices that can influence its trajectory during launching.

Advantageously, said body has a general parallelepiped shape and comprises two upper guide rails and two lower guide rails parallel to one another and parallel to the longitudinal sides of said body.

The device of the invention is intended to be used with satellites having a transverse cross-section with a general rectangular shape. Thus, this device construction is a simple and reliable solution for translation movement in order to eject the satellite in a clearly defined direction, while minimizing torque, and while offering the possibility to vary the drive speed of the moving means and therefore adapt it to the mission of each satellite.

In an alternative, said drive means include at least one upper drive element for each satellite attached to at least one cable, which moves in translation parallel and above said upper rails.

In another alternative, said drive means include at least one lower drive element for each satellite attached to at least one cable that moves in translation parallel and below the lower rails.

In these two alternatives, the driving can be performed in a simplified and economical manner, by a cable in the upper portion, by a cable in the lower portion, or by a cable in the upper portion and a cable in the lower portion, which cable has elements for driving each satellite. The elements for driving each satellite move according to a rectilinear trajectory, in a direction parallel to the guide rails, and the cable can receive the driving from a pulley rotated by an electric motor around an axis transversal to the direction of movement of the cable.

Advantageously, each upper and lower drive element includes two longitudinal drive elements each secured to a cable and connected to one another by a spacer coming into contact with a lateral face of the satellite, in which the satellite is axially attached by two spacers coming into contact with the front face and the rear face thereof, respectively.

The satellite is thus axially attached by being sandwiched between two transverse spacers. This solution enables simple and reliable driving by a lateral thrust imparted on each satellite, while enabling the drive elements to become disengaged from each satellite after ejection of same.

Preferably, said upper and lower spacers move on secondary longitudinal guide rails.

This makes it possible to ensure good translational guiding of the drive elements, which then actuate the satellites by a lateral thrusting force that is uniform over their entire length.

Advantageously, said secondary longitudinal guide rails are staged. Each staged rail thus forms a guide segment cooperating with a spacer having a length corresponding to the transverse spacing of two rails of the same segment, making it possible to obtain axial stops at the end of each segment. This enables axial blocking of each satellite in the transport position.

Preferably, said body includes means for supplying power to said control means. This enables a self-contained device that is simpler to produce, without requiring the use of electrical conductors for connection to the launching vehicle.

Advantageously, the device of the invention comprises at least one ejection sensor communicating with said control means.

Such an ejection sensor can be a camera or one or more mechanical movement sensors that inform said control means that the ejection has been completed, or that communicate the ejection parameters (time, speed, etc.).

The subject matter of the invention is also achieved with a method for ejecting small space payloads, in particular picosatellites, characterized in that it comprises the following steps:
arranging a satellite inside a device according to one of the previous claims;
attaching the satellite to the cable by sandwiching it between two front and rear drive means;
mounting said device on an external surface of a launching vehicle;
controlling the control means of said device after the launching of the launching vehicle so that said cable causes the drive means to move, releasing the satellite.

According to an alternative of the invention, the method for ejecting small space payloads, in particular picosatellites, comprises the following steps:
arranging at least two satellites one behind the other inside a device according to one of the previous claims, in which each satellite comprises its own drive means;
mounting said device on an external surface of a launching vehicle;
controlling the control means of said device after launching the launching vehicle so that the drive means release one satellite at a time.

### DESCRIPTION OF THE FIGURES

FIG. 1 shows a perspective view of the device of the invention in the satellite ejection position.

FIG. 2 is a perspective view of the device of the invention in the satellite storage position.

FIG. 3 is a vertical axial cross-section view of the device of FIG. 2.

FIG. 4 is a perspective view from a different angle of the device of FIG. 1, in which the front wall of the device is removed.

FIG. 5 is a transverse cross-section view produced with a plane containing axis x-x′ of the device of FIG. 1.

FIG. 6 is a perspective view showing two adjacent drive elements.

FIG. 7 is a perspective view showing a satellite drive element produced according to an alternative of the invention.

### LIST OF REFERENCES

| | |
|---|---|
| 1 | device |
| 2 | body |
| 3 | attachment means |
| 4 | left-hand front wall |
| 5 | right-hand front wall |
| 6 | lower wall |
| 7 | upper wall |
| 8 | door |
| 9 | satellite |
| 10 | transport installation |
| 11 | guide means |
| 12 | ejection mechanism |
| 13 | control means |
| 14 | drive means |
| 15 | rear end |
| 16 | front end |
| 17 | upper guide rail |
| 18 | lower guide rail |
| 19 | cable |
| 20 | cable |
| 21 | electric motor |
| 22 | upper drive element |
| 23 | lower drive element |
| 24 | driving pulley |
| 25 | angle deflection pulley |
| 26 | lower front pulley |
| 27 | lower rear pulley |
| 28 | upper rear pulley |
| 29 | upper front pulley |
| 30 | front face |
| 31 | rear face |
| 32 | longitudinal drive element |
| 33 | spacer |
| 34′, 34″, 34″′ | internal longitudinal guide rail |
| 35′, 35″, 35″′ | axial stop |
| 36 | snap-lock device |
| 37 | piston |
| 38 | spring |
| 39 | cylinder |
| 40 | orifice |
| 41 | bearing |
| 42 | attachment screw |
| 43 | guide end |
| 44 | guide loop |
| 45 | additional guide element |

### DETAILED DESCRIPTION OF THE INVENTION

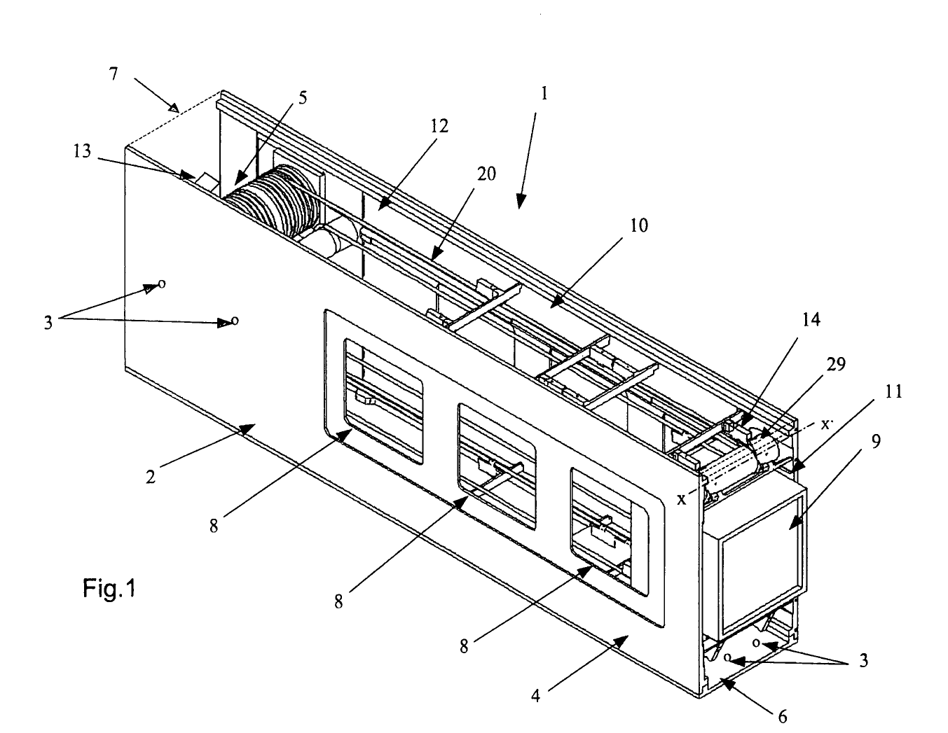

FIG. 1 shows a perspective view of a device 1 for transporting and ejecting small space payloads according to the invention, in particular picosatellites, referred to as satellites 9 below. The satellites 9 are bodies with a general cubic shape produced according to the CubeSat standard. Satellites with a rectangular shape derived from the CubeSat satellites (for example having the same transverse cross-section, but a longer length) can also be used with the device of the invention. The device 1 of the invention comprises an elongate tubular body 2, with a rectangular transverse cross-section. In the example shown in the appended figures, the body 2 is produced by the assembly, using an attachment screw, of four rectangular panels, in particular a left front wall 4, a right front wall 5, a lower wall 6 and an upper wall 7, in which the later is shown transparently and illustrated with totted lines in FIG. 1. The body 2 can be made by mechanical assembly of a plurality of panels mechanically machined, for example by milling, and made of a suitable metal alloy, such as aluminum alloy 6061, 7075, 2024, 7049 as well as titanium or magnesium alloys, or Teflon; the body 2 can also be made by molding of a suitable metal alloy, such as aluminum alloy 6061, 7075, 2024, 7049, as well as a titanium or magnesium alloy, or a composite material comprising carbon fibers; the body 2 can also be obtained by being sized in the mass from a suitable metal alloy, such as aluminum alloy 6061, 7075, 2024, 7049, as well as titanium or magnesium alloys, or a fiberglass paste. The side walls of the body 2 are equipped with means for attachment 3 to the fairing of a launching vehicle. The attachment means 3 shown in the figures are orifices through which attachment screws (not shown in the figures) pass, and the attachment of the device 1 to the fairing can be performed according to one or the other of the walls thereof.

The front walls 6 and 7 comprise doors 8 enabling access to a satellite 9 when it is arranged in the storage position inside the device 1. The satellites 9 are introduced into the body 2 of the device, from the front end 16 of same, by sliding on the guide means 11, in particular two upper guide rails 17 and two lower guide rails 18, produced parallel to the longitudinal axis of the body 2. The guide rails 17 and 18 are attached to the internal walls of the body 2 of the device 1 or are formed in a single piece with it. Preferably, the rails 17 and 18 are arranged so as to be capable of guiding each satellite corner, and two upper rails 17 and two lower rails 18 having a square-shaped transverse cross-section are provided inside the body 2.

Each satellite 9 is mounted stationarily in a storage position during transport and until launching. The device 1 includes, inside the body 2, means 13 for controlling an ejection mechanism 12 that, owing to the driving means 14 of each satellite, enables the satellites to move in longitudinal translation between a rear end 15 and a front end 16 of the body 2. Owing to the stationary mounting of each satellite during transport, as will be explained below, this device does not require a closure door at the front 16 or rear 15 ends of the body 2.

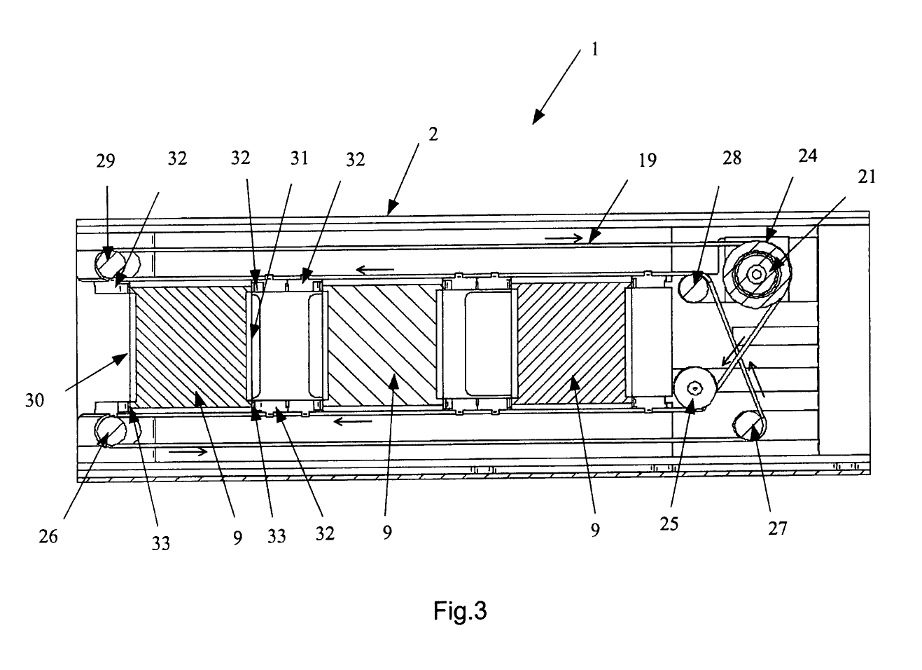

The ejection mechanism 12 of the invention includes a transport installation 10 comprising two parallel cables 19, on which an upper drive element 22 and a lower drive element 23, respectively, are attached, with two upper elements 22 and two lower elements 23 sandwiching a satellite 9 as will be described below. The transport installation 10 includes two cables 19 and 20 extending in a closed loop from a driving pulley and passing through a plurality of intermediate or transfer pulleys before being wound on the driving pulley 24. The driving pulley 24 comprises grooves on its external surface, grooves produced according to a helical profile at the level of each cable, in which two helical profiles with opposite inclinations are produced on each side of the center so as to enable the guiding, during winding and unwinding, of the cable 19 and the cable 20. The axis of rotation of the pulley 24 is perpendicular to the direction of the guide rails 17, 18, and the longitudinal axis of the body 2 of the device 1. The driving pulley 24 is located in the upper portion and at the rear end 15 of the body 2 of the device 1, and each of the cables 19, 20 leaving the driving pulley 24 passes through intermediate pulleys so as to obtain passage areas parallel to the guide rails 17, 18 before returning to the driving pulley 24. Thus, each cable 19, 20 leaving the driving pulley 24 passes through a lower angle deflection pulley 25, then through a lower front pulley 26 causing it to make a half-turn toward a lower rear pulley 27, from which it is sent to an upper rear pulley 28, then to an upper front pulley 29 causing it to make a half-turn toward the driving pulley 24. The path covered by the cable 19 can be better seen in FIG. 3, in which the arrows indicate the direction of movement of the cable as the driving pulley 24 is rotated by a motor 21 and by a reducer (not shown in the drawings) arranged inside the driving pulley 24.

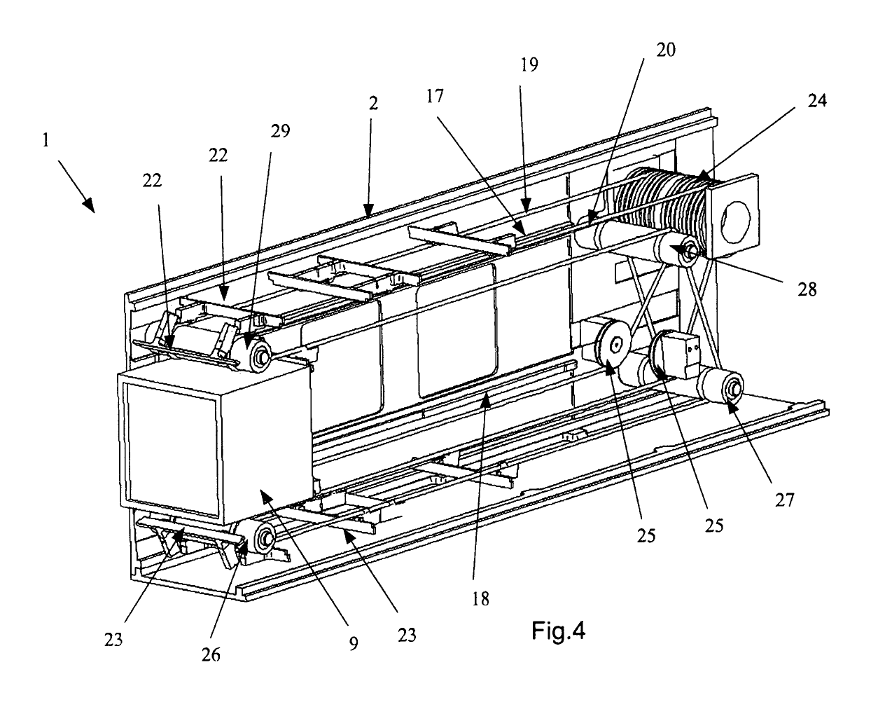

As can be seen in FIG. 4, the path covered by the cable 20 is symmetrical (according to a middle vertical plane of symmetry) with that of the cable 19. Two angle deflection pulleys 25 are provided so as to prevent the crossing of cables 19 and 20, respectively, and are mounted using attachment screws to the front walls of the body 2, so that the axis of rotation of each one has an inclination with respect to the vertical of an angle between 2° and 35°. The other transfer pulleys, in particular pulleys 26, 27, 28 and 29, each have an axis of rotation parallel to that of the driving pulley 24.

The cable of the invention is preferably made of a Kevlar-type material with a diameter of between 2 mm and 6 mm, and, preferably, equal to around 4 mm. Tensioning devices can be provided on the path.

The driving pulley 24 is guided by a groove with a corresponding shape produced in one of the front walls of the body 2 and it is attached using attachment screws to said wall. The intermediate pulleys 26, 27, 28 and 29 are attached by snap-lock devices 36 on the front walls 4, 5 of the body 2, as will be explained below.

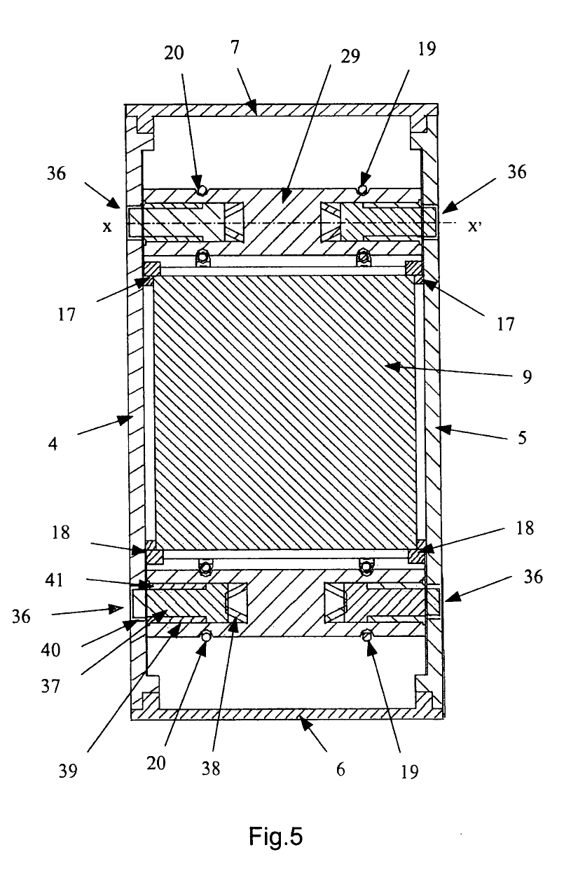

Such a snap-lock mechanism 36 can be better seen in FIG. 5. FIG. 5 is a transverse cross-section view with a vertical plane passing through a first x-x′ axis, which is the axis of rotation of the pulley 29 and through a second axis of rotation, that of the pulley 26, which is parallel to the first. Each pulley 26, 29 is attached to each of the front walls 4, 5 by using a snap-lock device 36. A snap-lock device 36 includes a piston 37 slidingly mounted inside a blind cylinder 39 under the force of a spring 38. Each front wall includes an orifice 40 through which the piston 37 passes when the pulley 26 is mounted (the same applies to pulleys 27, 28 and 29) in the body 2 of the device 1. A piston 37 comprises an end with a larger diameter, on which the spring 38 is supported, and a free end that passes through the orifice 40 of the wall. The free end of the piston 37 and the orifice 40 of the wall have the same shape, which can be circular or oval, or even polygonal, etc. Bearings 41 made of a material with a low friction coefficient, such as Teflon, ensure the guiding in rotation of the pulleys.

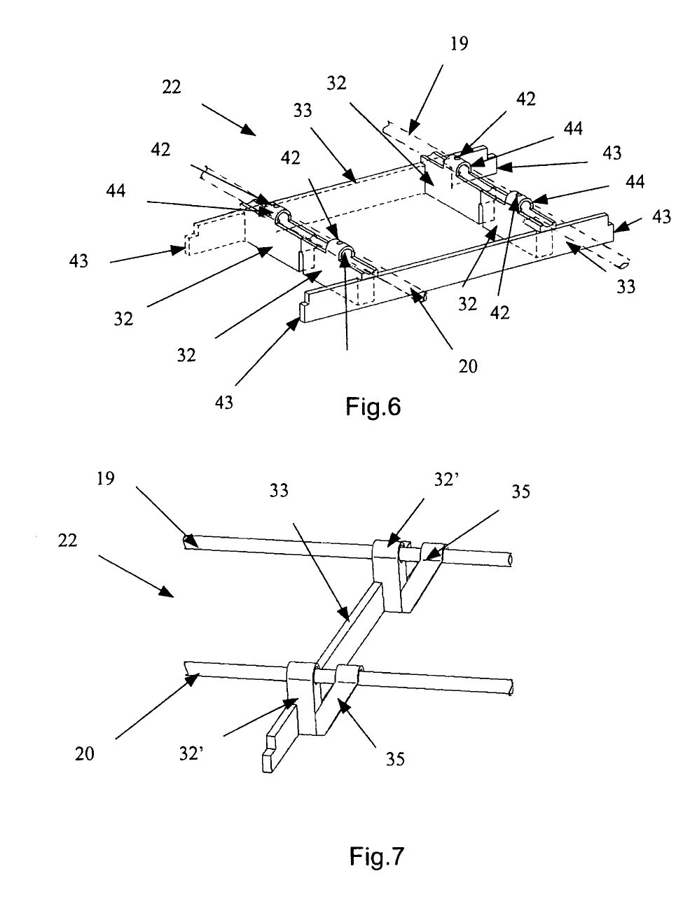

FIG. 6 shows two adjacent upper drive elements 22 illustrated on an enlarged scale. An upper drive element 22 includes two parallel longitudinal drive elements 32 mounted one on a cable 19 and the other on the cable 20 by being linked on one side by a spacer 33 and forming a single piece. Each longitudinal drive element 32 is a part with a general parallelepiped shape, with the longest side being arranged along a cable 19, 20 that passes through a guide loop 44 produced in the upper portion of each element. Each longitudinal drive element 32 is attached to the cable 19 and 20, respectively, by an attachment screw 42 passing through the center of the guide loop 44. In an alternative, one or more attachment screws is (are) inserted from low to high, from the base and through the parallelepiped body of the longitudinal drive element 32 to the cable 19 and 20, respectively. Each spacer 33 is intended to come into contact with each side face of a satellite; in particular, in reference to FIG. 6, the spacer 33 located in front comes into contact with the rear face 31 of a first satellite 9 and the spacer 33 located at the back is intended to come into contact with the front face 30 of a second satellite 9 located behind the first inside the body 2 of the device of the invention. In this way, the distance between two neighboring spacers 33 determines the distance that separates two satellites 9 inside the body 2 of the device. The lower drive elements 23 are identical to the upper drive elements 22.

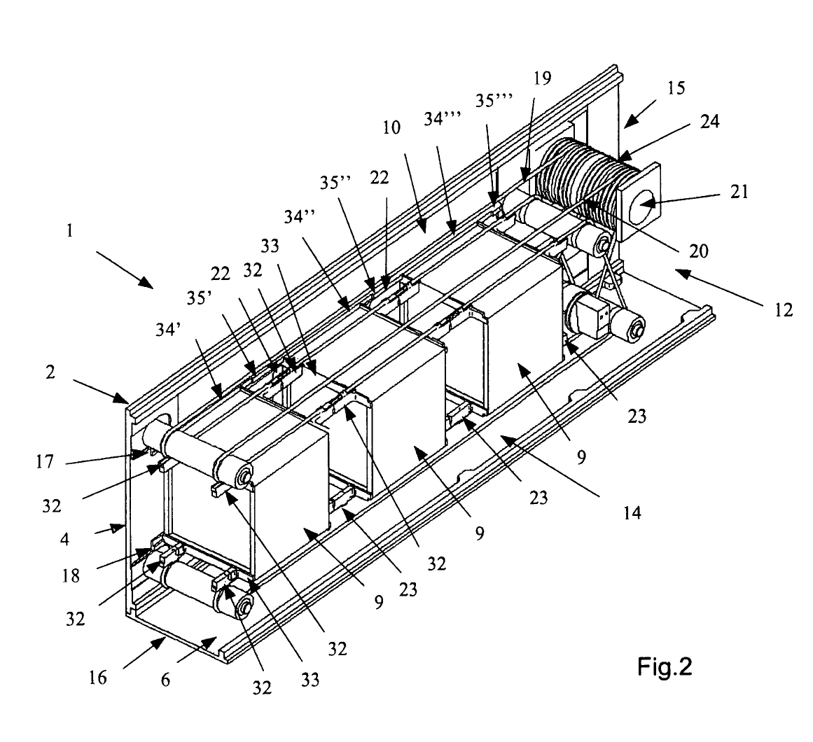

The spacers 33 each comprise two guide ends 43 sliding on internal longitudinal guide rails 34,′, 34″, 34′″ thus forming three staged segments, of increasing width in the direction of the front end 16 of the body 2 (FIG. 2). Each internal longitudinal rail 34′, 34″, 34′″ is equipped with an axial stop 35′, 35″, 35′″. Each staged rail thus forms a guide segment cooperating with a spacer 33 having a length corresponding to the transverse spacing of two rails of the same segment, which makes it possible to obtain axial stops at the end of each segment and therefore to produce an axial blocking of each satellite 9 in the transport position.

FIG. 7 shows an alternative embodiment of an upper drive element 22, in which the longitudinal drive elements 32′ are shorter than the longitudinal drive elements 32 of FIG. 6 and are extended by additional guide elements 45 coming into contact with the drive elements 32′. An adjacent upper drive element 22 is produced in the same way and mounted opposite the first. The lower drive elements 23 are identical to the upper drive elements 22, and the drive elements 22, 23 produced according to this alternative enable better guiding along the cable, which is thus under less torsional stress.

The body 2 also integrates means for supplying electric power to the control means 13, for example a Li-ion or Li-polymer battery or any other type of battery that provides a high weight/energy ratio. Electrical connection means can be provided between the satellites and the battery, enabling power supply until ejection time.

The device 1 as shown in the appended figures is intended to receive three satellites 9. The satellites are arranged one behind another inside the body 2 by being supported and guided by the guide rails 17, 18. Each satellite 9 is attached by the drive elements 22 and 23, and their spacers 33 sandwich it in the upper portion and the lower portion of the front face 30 and the rear face 31 of the satellite. When all of the satellites 9 have been introduced on the guide rails and mounted on the cables 19, inside the body 2, the device 1 can be attached to the fairing of the launching vehicle. After launching of the vehicle and when the launching altitude of a first satellite is reached, the control means supply power to the electric motor 21, which causes the driving pulley 24 to rotate, causing a rectilinear and simultaneous movement of the cables 19 and 20. A first satellite 9 is thus caused to move, by being driven by the first drive elements 22, 23 and arrives at the front end 16 of the body 2, from which it is ejected into space. The speed of ejection of a satellite 9 is between 1 and 3 m/s. When it receives the ejection signals coming from the control unit 13, the device 1 performs the same operations in order to eject a second satellite. The operation continues until all of the satellites contained in the body 2 have been launched. As can be better seen in FIG. 4, after ejection of a satellite 9, the drive elements 22 and 23 follow the winding movement of the cables 19 and 20 and pass through the upper and lower portions, respectively, of the body 2, beyond the guide rails 17 and 18, respectively. The drive means are thus secured to the cables, which are separate from the guide rails of the satellite, and the trajectory of the satellite is that imparted by the direction of the guide rails, thereby preventing the appearance of any parasitic torque during driving.

Other alternatives and embodiments of the invention can be envisaged without going beyond the scope of the claims.

Thus, in one alternative (not shown in the figures) the device of the invention can store, then eject, a plurality of satellites, for example six satellites arranged in the same body. In another alternative, two tubular bodies are arranged one against the other, in the longitudinal direction, and use a common ejection mechanism.

In another alternative, the drive elements can be secured to the satellite by being removably mounted on each cable so as to be capable of becoming disengaged from it at the front end of the body of the device in order to enable ejection of the satellite.

1. Device (1) for transporting and ejecting small space payloads, in particular picosatellites, including:
a body (2) with a tubular shape equipped with means for attachment (3) to a launching vehicle; said body (2) comprises at least two longitudinal guide rails (17, 18) capable of receiving a satellite (9) arranged stationarily inside said body (2) in a storage position during transport and capable of being caused to move along said guide rails (17, 18) in the direction of a front end (15) of said body (2) during ejection;
an ejection mechanism (12) comprising means for moving a satellite in a longitudinal translation movement (9);
drive means (14) connected to said moving means, capable of cooperating with a satellite (9); and
means for controlling (13) the ejection mechanism (12),
characterized in that said moving means include a transport installation (10) comprising at least one cable (19, 20) extending in a closed loop inside the body (2), said closed loop passes around said guide rails (17, 18) and comprises passage areas extending parallel on each side of the guide rails (17, 18) so that, when said cable (19, 20) is moved by said control unit (13), it actuates said drive means so as to move the satellite (9) on said rails in the direction of the front end (15) of said body (2).

2. Device according to claim 1, characterized in that said cable (19, 20) extends in a closed loop from a driving pulley (24), which is located at a rear end (15) of said body (2), the cable (19, 20) leaving the driving pulley (24) passes through an angle deflection pulley (25), then through a lower front pulley (26) causing it to make a half-turn toward the lower rear pulley (27), from which it is sent to an upper rear pulley (28), then to an upper front pulley (29), causing it to make a half-turn toward the driving pulley (24).

3. Device according to claim 1, characterized in that the transport installation (10) includes two parallel cables (19, 20) each following the same closed-loop path from the same driving pulley (24)

4. Device according to claim 2, characterized in that said driving pulley (24) contains an electric motor (21) of which the current power supply is controlled by said control means (13).

5. Device according to claim 1, characterized in that said drive means (14) are mounted stationarily on said cable (19, 20) and are capable of becoming disengaged from the satellite (9) at the time of ejection of the latter.

6. Device according to claim 1, characterized in that said drive means are intended to be capable of cooperating with at least two satellites (9) arranged one behind the other, inside said body (2).

7. Device according to claim 1, characterized in that two adjacent satellites (9) are arranged at a predetermined distance from one another inside said body (2).

8. Device according to claim 7, characterized in that said control means (13) include a microprocessor/microcontroller and said distance is introduced into the memory of the microprocessor/microcontroller.

9. Device according to claim 1, characterized in that said body has a general parallelepiped shape and comprises two upper guide rails (17) and two lower guide rails (18) parallel to one another and parallel to the longitudinal sides of said body (2).

10. Device according to claim 9, characterized in that said drive means (14) include an upper drive element (22) attached to at least one cable (19, 20), which moves in translation parallel and above said upper rails (17) and a lower drive element (23) attached to at least one cable (19, 20), which moves in translation parallel and below the lower rails (18).

11. Device according to claim 10, characterized in that each upper (22) and lower (23) drive element, respectively, includes two longitudinal drive elements (32) each secured to a cable (19, 20) and connected to one another by a spacer (33) coming into contact with a side face of the satellite (9), in which the satellite is axially attached by two spacers (33) supported one on the front face (30) and the other on the rear face (31) thereof.

12. Device according to claim 11, characterized in that said upper and lower spacers (33) move on internal longitudinal guide rails (34′, 34″, 34′″).

13. Device according to claim 12, characterized in that said internal longitudinal guide rails (34′, 34″, 34′″) are staged.

14. Device according to claim 1, characterized in that said body (2) contains means for supplying power to said control means (13).

15. Device according to claim 1, characterized in that it comprises at least one ejection sensor communicating with said control means (13) and/or with the launcher directly.

16. Method for ejecting small space payloads, in particular picosatellites, characterized in that it comprises the following steps:
arranging a satellite inside a device according to claim 1;
attaching the satellite to the cable by sandwiching it between two front and rear drive means;
mounting said device on an external surface of a launching vehicle;
controlling the control means of said device after the launching of the launching vehicle so that said cable causes the drive means to move, releasing the satellite.

17. Method for ejecting small space payloads, in particular picosatellites, according to claim 16, characterized in that it comprises the following steps:
arranging at least two satellites one behind the other inside said device in which each satellite comprises its own drive means;
mounting said device on an external surface of a launching vehicle;
controlling the control means of said device after launching the launching vehicle so that the drive means releases one satellite at a time.
